(19) United States
(12) Patent Application Publication
(10) Pub. No.: US 2025/0084940 A1
(43) Pub. Date: Mar. 13, 2025

(54) Arrangement Having a Coupling Connection

(71) Applicant: AS Strömungstechnik GmbH, Ostfildern (DE)

(72) Inventors: Andreas Szeteli, Filderstadt (DE); Nico Fischer, Stuttgart (DE); Timo Lang, Filderstadt (DE)

(21) Appl. No.: 18/809,403

(22) Filed: Aug. 20, 2024

(30) Foreign Application Priority Data
Sep. 11, 2023 (DE) 102023124463.9

(51) Int. Cl. F16L 33/24; F16L 55/07

(52) U.S. Cl. CPC F16L 33/24; F16L 55/07

(57) ABSTRACT

An arrangement having a coupling connection comprising two coupling parts. The coupling parts can be connected by means of a screw connection and form a fluid channel. On the first coupling part there is a multi-start thread as a connection means as part of the screw connection. On the second coupling part there is a multi-start mating thread as a connection means as a further part of the screw connection.

### CROSS REFERENCE TO RELATED APPLICATIONS

This application claims the priority of DE 102023124463.9 filed on 2023 Sep. 11; this application is incorporated by reference herein in its entirety.

### BACKGROUND

The invention relates to an arrangement having a coupling connection.

Such an arrangement is generally used to transport fluid via a fluid channel. The arrangement comprises a coupling connection with two coupling parts. The coupling connections are connected by means of a screw connection to form the fluid channel.

A typical application example is a tank truck that transports fluid in a tank. The tank truck delivers fluid, in particular for a container arranged stationary in a building. The fluid can be in the form of specialty chemicals that are required to carry out industrial processes, e.g. in the semiconductor industry. The container or containers are then integrated into corresponding industrial buildings.

There is a tank on the tank truck, which tank is connected to a coupling part via a line. The container in the building is connected directly or via another line to a further coupling part.

To deliver fluid, the tank truck drives up to the building so that the coupling part located there can be connected to the coupling part by the screw connection to form the coupling connection. This creates a continuous fluid channel from the tank to the container so that fluid can be conveyed from the tank into the container.

To form the screw connection, one of the coupling parts has a thread and the further coupling part has a mating thread.

Creating the screw connection is relatively cumbersome and time-consuming, as the mating thread must be turned relative to the thread over several revolutions, typically three to four revolutions, to create a stable screw connection.

Another disadvantage is that the thread and the mating thread easily jam. This not only makes it more difficult to create the screw connection. Rather there is a considerable risk of damage to the thread and mating thread. There is a risk of damage in particular if the thread and mating thread consist of plastic.

### SUMMARY

The invention relates to an arrangement (1) having a coupling connection (9) comprising two coupling parts (10, 11). The coupling parts (10, 11) can be connected by means of a screw connection and form a fluid channel. On the first coupling part (10) there is a multi-start thread (13) as a connection means as part of the screw connection. On the second coupling part (11) there is a multi-start mating thread (19) as a connection means as a further part of the screw connection.

### DETAILED DESCRIPTION

The object of the invention is to provide a connection means with a high degree of functionality and functional reliability for an arrangement of the type described above.

The features of claim 1 are provided to solve this object. Advantageous embodiments of the invention and appropriate further developments are described in the dependent claims.

The invention relates to an arrangement having a coupling connection comprising two coupling parts. The coupling parts can be connected by means of a screw connection and form a fluid channel. On the first coupling part there is a multi-start thread as a connection means as part of the screw connection. On the second coupling part there is a multi-start mating thread as a connection means as a further part of the screw connection.

With the arrangement according to the invention, fluid is generally conveyed via a fluid channel.

The fluid channel for conveying fluid is formed by establishing a coupling connection by connecting two coupling parts by means of a screw connection.

According to the invention, one coupling part has a multi-start thread as connection means. The further coupling part has a corresponding multi-start mating thread. With the coupling parts formed in this way, a screw connection can be formed quickly and reliably, i.e. the coupling connection can be formed quickly and easily with the coupling parts to provide the fluid channel.

A significant advantage of the multi-start thread according to the invention is that a secure and stable screw connection can be created with only a few revolutions, preferably only one third of a revolution, of the multi-start thread relative to the multi-start mating thread.

A further significant advantage of the multi-start thread according to the invention is that when the multi-start thread is screwed onto the multi-start mating thread, the risk of jamming is considerably reduced compared to conventional single-start threads. Such jamming not only delays the creation of the screw connection, since after jamming the multi-start thread must be repositioned on the multi-start mating thread. Rather, such jamming bears the risk of damaging the multi-start thread and/or the multi-start mating thread, so that a screw connection can then no longer be created. This risk exists in particular if the connection means with the multi-start thread and the multi-start mating thread consist of plastic.

According to an advantageous embodiment, the multi-start thread is an outer thread and the multi-start mating thread is an inner thread.

The screw connection formed in this way is in particular fluid-tight, so that no leaks occur at the screw connection.

According to a structurally advantageous embodiment, the outer thread is arranged on the outside of a hollow cylindrical shaft of the first coupling part.

Corresponding to this, the inner thread is arranged in a union nut of the second coupling part.

The screw connection formed in this way has a simple, robust design and can be easily closed and disconnected again.

The screw connection is established or disconnected by manually operating the union nut.

Manual operation can be carried out quickly and easily, as only a few, preferably only one third of a turn of the multi-start thread relative to the multi-start mating thread is required to establish the screw connection.

Once the screw connection has been formed and the coupling connection established, fluid can flow via the coupling connection as part of the fluid channel.

Advantageously, there is a valve in each coupling part, wherein the valves are open when the coupling connection is formed.

The opening and closing of the valves is advantageously positively guided, in particular via mechanical actuating mechanisms.

If the coupling parts are separated from each other, locking means in the coupling parts ensure that the valves are closed so that no fluid can escape from the coupling parts. Once the coupling parts are connected, the valves are opened by means of the actuating mechanisms so that fluid can flow through the fluid channel in the coupling connection.

According to an advantageous embodiment, the connection means of the coupling parts consist of plastic, wherein advantageously the entire coupling parts are made of plastic parts.

The aforementioned parts can then be manufactured efficiently and cost-effectively as plastic injection-molded parts. They are also more acid-resistant than metal parts, which can also be used.

Since the connection means consist of plastic, the multi-start threads also consist of plastic. However, this is non-critical because the design of the threads as multi-start threads prevents jamming when creating the screw connection and thus no damage to the multi-start threads is to be feared.

By establishing the screw connection between the coupling parts, the coupling connection is established, thus providing a fluid channel for fluid transport. In general, fluid can thus be transported from one container to another container via the fluid channel.

According to an advantageous embodiment, a fluid channel is formed between the tank of a tank truck and a stationary container, preferably arranged in a building, by forming the coupling connection, so that fluid is conveyed from the tank into the container. In general, it is of course also possible to convey fluid in the opposite direction.

Typically, the coupling part provided on the tank truck is connected to the tank via a line, such as a hose. The further coupling part of the coupling connection is provided directly on the container or connected thereto via a line, such as a hose or pipeline.

### BRIEF DESCRIPTION OF THE DRAWINGS

The invention is explained below on the basis of the drawings. The Figures show:

FIG. 1: Schematic representation of an embodiment example of the arrangement having a coupling connection according to the invention.

FIG. 2: Perspective representation of the coupling parts of the coupling connection according to FIG. 1.

FIG. 3: Side view of the coupling parts according to FIG. 2.

### DETAILED DESCRIPTION OF THE PREFERRED EMBODIMENTS

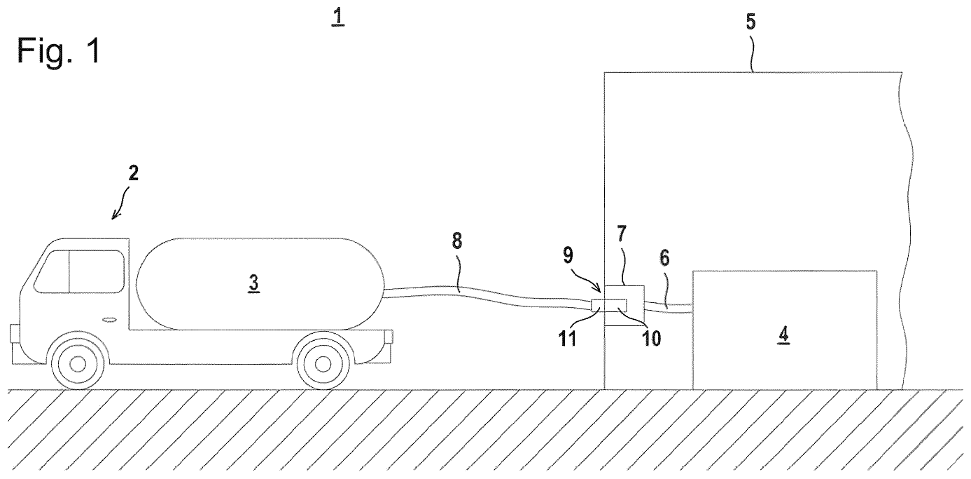

FIG. 1 shows a highly schematized arrangement of the arrangement 1 according to the invention.

The arrangement 1 comprises a tank truck 2 having a tank 3 in which fluid is stored. The fluid may be fluid specialty chemicals that are required to carry out industrial processes.

The fluid delivered in the tank 3 of the tank truck 2 is fed to a container 4, which is arranged stationary. In the present case, the container 4 is arranged in an industrial building 5.

In the present case, the container 4 is connected to a connection unit 7 via a line 6, which may be formed by a pipeline or a hose. In principle, the container 4 can be connected directly to the connection unit 7.

A line 8 is led from the tank 3 of the tank truck 2 to the connection unit 7, wherein the line 8 is advantageously formed by a hose.

In order to form a continuous fluid channel from the tank 3 to the container 4 via the lines 6, 8, a coupling connection 9 is provided in accordance with the invention. The coupling connection 9 comprises two coupling parts 10, 11, wherein a first coupling part 10 is arranged in the connection unit 7 and a second coupling part 11 is arranged at the free end of the line 6 coupled to the tank 3.

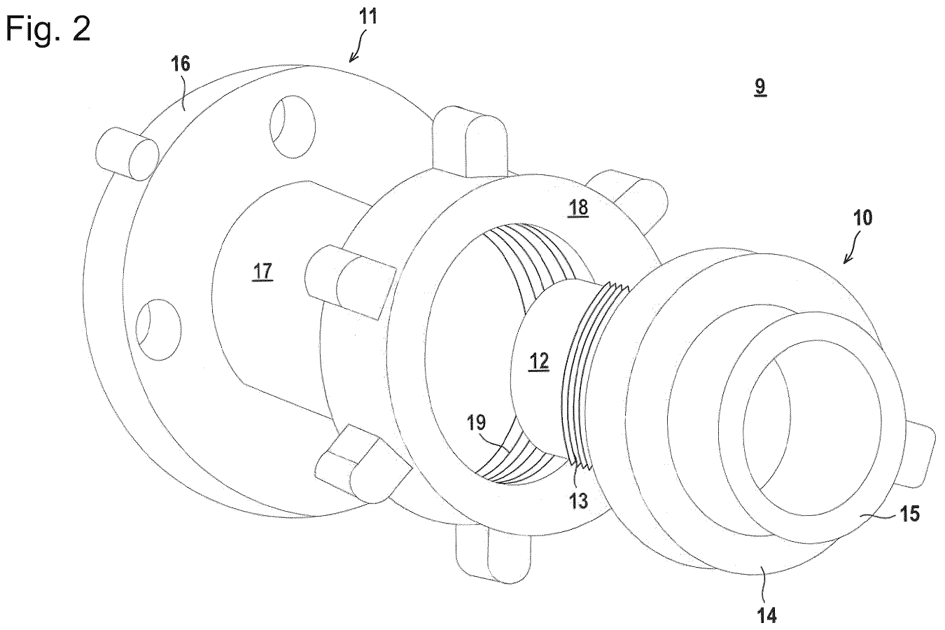

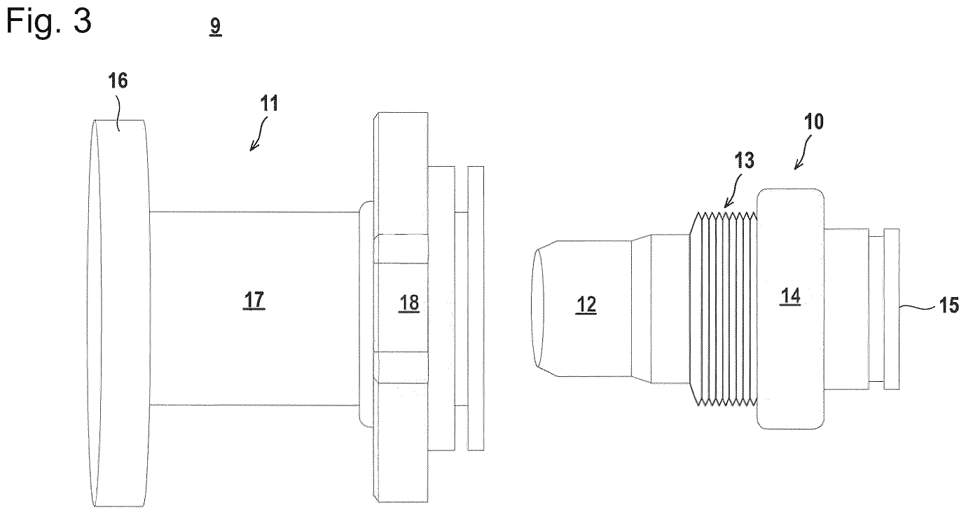

The coupling connection 9 with the two coupling parts 10, 11 is shown separately in FIGS. 2 and 3.

The coupling parts 10, 11 consist of plastic, wherein the coupling parts 10, 11 are constructed from one or more plastic injection-molded parts. The coupling parts 10, 11 form tubular hollow bodies in which fluid can be transported.

The coupling parts 10, 11 can be connected to form the coupling connection 9 by means of a screw connection. The screw connection is operated manually to connect or disconnect the coupling parts 10, 11.

A valve is provided in each coupling part 10, 11 (not shown in the Figures).

The opening and closing of the valves is advantageously positively guided, in particular via mechanical actuating mechanisms.

If the coupling parts 10, 11 are separated from each other, locking means in the coupling parts 10, 11 ensure that the valves are closed so that no fluid can escape from the coupling parts 10, 11. Once the coupling parts 10, 11 are connected to each other, the valves are opened by means of the actuating mechanisms so that fluid can flow via the fluid channel in the coupling connection 9.

Control elements can be provided to operate the actuating mechanisms. Alternatively, the actuating mechanisms are operated automatically when the coupling connection 9 is established or disconnected.

To establish the screw connection, the coupling parts 10, 11 have connection means, each consisting of plastic.

As FIGS. 2 and 3 show, the first coupling part 10 essentially consists of a hollow cylindrical body. On the front side facing the second coupling part 11, the first coupling part 10 has a hollow cylindrical shaft 12. A multi-start thread 13 in the form of an outer thread is provided as a first connection means on the outer jacket surface of the hollow cylindrical shaft 12. A widened segment 14 of the tubular body adjoins the multi-start thread. On the rear side facing away from the second coupling part 11, the coupling part 10 has a connection contour 15 for connection to the line 6 or the container 4.

The second coupling part 11 also consists essentially of a hollow cylindrical body. A flange 16 for connection to the line 8 leading to the tank 3 is located on the rear side of the second coupling part 11 facing away from the first coupling part 10.

A union nut 18 is mounted on a hollow cylindrical pipe segment 17.

A multi-start mating thread 19 in the form of an inner thread is located on the inner wall of the union nut 18 as a second connection means.

Both the multi-start thread 13 and the multi-start mating thread 19 have a plurality of starting cuts.

The coupling connection 9 is formed by establishing the screw connection with the multi-start thread 13 and the corresponding multi-start mating thread 19 by screwing the union nut 18 with the multi-start mating thread 19 onto the multi-start thread 13. The coupling connection 9 forms a fluid-tight connection so that fluid can flow through the coupling connection 9 as part of the fluid channel without the risk of leakage.

Since the outer thread and inner thread of the connection means are designed as multi-start threads, few revolutions, preferably only one third of a revolution, of the outer thread on the inner thread, are sufficient to form the screw connection firmly and stably. By designing the connection means as multi-start threads, jamming of the outer thread on the inner thread is avoided.

As soon as the coupling parts 10, 11 are connected to form the coupling connection 9 by forming the screw connection between the multi-start thread 13 and the multi-start mating thread 19, fluid can be supplied from the tank 3 to the container 4 via the fluid channel.

After the filling process, the coupling parts 10, 11 are separated again by disconnecting the screw connection.

### LIST OF REFERENCE NUMERALS

(1) Arrangement
(2) Tank truck
(3) Tank
(4) Container
(5) Industrial building
(6) Line
(7) Connection unit
(8) Line
(9) Coupling connection
(10) Coupling part
(11) Coupling part
(12) Hollow cylindrical shaft
(13) Multi-start thread
(14) Segment
(15) Connection contour
(16) Flange
(17) Pipe segment
(18) Union nut
(19) Multi-start mating thread

1. An arrangement (1) having a coupling connection (9) comprising two coupling parts (10, 11) which can be connected by means of a screw connection and form a fluid channel, characterized in that on the first coupling part (10) there is a multi-start thread (13) as a connection means as part of the screw connection, and in that on the second coupling part (11) there is a multi-start mating thread (19) as a connection means as a further part of the screw connection.

2. The arrangement (1) according to claim 1, characterized in that the multi-start thread is an outer thread, and in that the multi-start mating thread is an inner thread.

3. The arrangement (1) according to claim 2, characterized in that the outer thread is arranged on the outside of a hollow cylindrical shaft (12) of the first coupling part (10).

4. The arrangement (1) according to claim 2, characterized in that the inner thread is arranged in a union nut (18) of the second coupling part (11).

5. The arrangement (1) according to claim 4, characterized in that the screw connection is established or disconnected by manually operating the union nut (18).

6. The arrangement (1) according to claim 1, characterized in that the connection means consist of plastic.

7. The arrangement (1) according to claim 1, characterized in that the coupling parts (10, 11) are made of plastic parts.

8. The arrangement (1) according to claim 1, characterized in that the first coupling part (10) is connected directly or via a line (6) to a container (4).

9. The arrangement (1) according to claim 1, characterized in that the second coupling part (11) is connected via a line (8) to a tank (3) of a tank truck (2).

10. The arrangement (1) according to claim 8, characterized in that the or each line (6, 8) is formed as a hose.

11. The arrangement (1) according to claim 1, characterized in that there is a valve in each coupling part (10, 11), wherein the valves are open when the coupling connection (9) is formed.
